(19) United States
(12) Patent Application Publication
(10) Pub. No.: US 2010/0169296 A1
(43) Pub. Date: Jul. 1, 2010

(54) Systems and Methods for Maintaining Records

(75) Inventors: John B. King, White Sulphur Springs, WV (US); Anthony W. Maro, White Sulphur Springs, WV (US)

Correspondence Address: MOAZZAM & ASSOCIATES, LLC, 7601 LEWINSVILLE ROAD, SUITE 304, MCLEAN, VA, 22102, US

(73) Assignee: EVRICHART, INC., Roanoke, VA (US)

(21) Appl. No.: 12/347,612

(22) Filed: Dec. 31, 2008

(51) Int. Cl. G06F 17/30; G06F 12/02

(52) U.S. Cl. 707/706; 707/E17.108; 707/E17.044; 707/E17.005

(57) ABSTRACT

Systems and methods are disclosed which relate to collecting, cataloguing, reproducing, and destroying records. Medical, legal, and other records from hospitals, medical offices, law offices, etc. are sent to a storage facility. Entry fields, such as name, record number, date of service, and date of birth, from each record are entered into a database. The database catalogues each record as well as the box the record is in and where the box is located. The system allows professionals to search the database over a secure connection. Multiple search fields allow a professional to search the database using any of a plurality of criterion. Search logic enables a cross-field search for a specific query. When professionals request a record, the record is pulled at the storage facility and physically or electronically sent to the professional. The system also keeps track of records eligible for destruction as well as those destroyed. Files eligible for destruction are destroyed after the requisite permission is given.

### BACKGROUND OF THE INVENTION

1. Field of the Invention

The present invention relates to document storage. More precisely, the present invention relates to collecting, cataloguing, reproducing, and destroying documents on request.

2. Background of the Invention

Medical records have higher standards, higher expectations, and higher rules and regulations for storage than other types of documents. However, in the field of storing records, often a very generalist approach to medical records is used in which they are viewed simply as a commodity. Typically, whichever company has the lowest price for storage usually receives the business. The medical record directors, physicians in hospitals, and attorneys all deal with a very poor retrieval rate and timeliness of retrievals because the medical records are treated as just another in a group of records that a vendor that might be storing.

When needed for continuity of care, litigation, audits, etc. it may be very difficult to find the correct records, if they can be found at all. Often there is very little care taken when the records are originally boxed up, not even documenting which files are in the boxes. With such important documents and such short time frames associated with request and retrievals, medical documents must be located quickly. Absence of these records, or failure to locate them in a timely fashion, can lead to lawsuits, patients being given duplicate tests, improper medication and so forth. Missing records have cost health care facilities substantial legal judgments. When facilities cannot produce a record, a destruction certificate must be produced. Without either of these, the facility will often lose the judgment and must either settle out of court or have a judgment against the facility.

Additionally, different state and federal guidelines specify how long a medical record needs to be retained. Each state has different guidelines; while one state might require that records be kept seven years after the last encounter, another state may require records be kept ten years. Most states also have provisions for minors, where the records must be held until the age of majority plus a certain number of years, or even permanently. When destroying records, regulations also require documentation of what records are being destroyed. This is a problem when documents have been shoved in a box, stuck in a back room and forgotten about. Often facilities themselves do not even know what is in the boxes. Before a box is destroyed, every record in the box must be itemized. However, mixed in the box may be, for instance, a minor's record with an adult record. These two types of documents have different retention guidelines. Therefore, it cannot just be assumed that a box can be destroyed. Certain states also have other caveats such as mental incompetence as a case why a record must be kept indefinitely, creating further uncertainty.

In many cases, a hospital takes all of their boxes of records and pays a storage vendor to store them in a warehouse, often forgetting that they exist. Most facilities over the years, because of the turnovers of chief financial officers (CFOs) and health information management (HIM) directors, do not have any idea of what they have in storage, where it is, or how to put their hands on it. This practice has left serious legal minefields for hospitals, because as long as they still had the records, they still had to be able to produce them in the event of litigation. Furthermore, many of these records remain in warehouses long after the records should have been destroyed.

In the new medical records environment, many of the records are in a digital format. However, the many companies which store or digitize medical records take from the overall medical records set only the cream of the crop. These are the most recent medical records and make the most sense to spend any money on to push them into an electronic environment. However, facilities are still left with the enormous burden of the baggage of old medical records. These old records continually cause problems for hospitals and medical professionals that become legacy issues from one director to another, one CFO to another, with no solutions.

Additionally, switching to a fully electronic system is difficult. Hospitals must pay for software, implement the system, train employees, etc. Many hospitals do not have the millions of dollars necessary to switch to a fully digital format and must continue to use paper records. These hospitals are forced to deal with the current inefficiencies, even at crucial times with highly at risk patients.

What is needed is a system to organize and categorize these records, allowing medical professional to produce the documents when they are needed. Furthermore, the categorization and exact location of all records would allow a health facility to be notified of the destruction status of documents, including whether they have already been destroyed or whether they are eligible for destruction. This would allow facilities to follow federal and state regulations while efficiently storing records.

### SUMMARY OF THE INVENTION

The present invention provides systems and methods for collecting, cataloguing, reproducing, and destroying records. Medical, legal, and other records from hospitals, medical offices, law offices, etc. are sent to a storage facility. Entry fields, such as name, record number, date of service, and date of birth, from each record are entered into a database. The database catalogues each record as well as the box the record is in and where the box is located. The system allows professionals to search the database over a secure connection. Multiple search fields allow a professional to search the database using any of a plurality of criterion. Search logic enables a cross-field search for a specific query. When professionals request a record, the record is pulled at the storage facility and physically or electronically sent to the professional. The system also keeps track of records eligible for destruction as well as those destroyed. Files eligible for destruction are destroyed after the requisite permission is given.

In one embodiment, the present invention is a system for collecting, cataloguing, reproducing, and destroying a record, comprising a server, a database in communication with the server, an entry device in communication with the server for entering data from a record, a logic on the server, a storage medium for storing the record, and a destroyer for destroying the record when the record is eligible for destruction. The logic provides a search engine for a user to search the database, and alerts a user when a record is eligible for destruction.

In another embodiment, the present invention is a system for checking and destroying a record from a database of records comprising a plurality of records, a means for periodically checking the plurality of records for destruction eligibility, and a means for destroying a record eligible for destruction. Destruction eligibility is in accordance with a plurality of guidelines.

In a further embodiment, the present invention is a method of improving record destruction, comprising cataloguing a plurality of records into a database, monitoring the database for a record eligible for destruction, and destroying the record eligible for destruction.

In yet another embodiment, the present invention is a method of improving record destruction of the type involving monitoring a database, which corresponds to a plurality of physical records, to find a physical record eligible for destruction, comprising destroying the physical record eligible for destruction. The physical record is found eligible for destruction according to a comparison of the database with a plurality of guidelines.

In another embodiment, the present invention is a method for improving medical record retrieval and destruction efficiency, comprising cataloguing a plurality of medical records into a database, searching the database for a plurality of exact matches and a plurality of possible matches, and retrieving a medical record from the database. The plurality of possible matches is included to improve a search result.

### BRIEF DESCRIPTION OF THE DRAWINGS

FIG. 1 shows a system for collecting, cataloguing, reproducing, and destroying documents, according to an exemplary embodiment of the present invention.

FIG. 2 shows a flowchart of a method of collecting, cataloguing, reproducing, and destroying documents, according to an exemplary embodiment of the present invention.

FIG. 3 shows a flowchart of the retrieval of records by a health care professional, according to an exemplary embodiment of the present invention.

FIG. 4 shows a sample screen of an MPI according to an exemplary embodiment of the present invention.

FIG. 5A shows a search form and results, according to an exemplary embodiment of the present invention.

FIG. 5B shows a search form and results, according to an exemplary embodiment of the present invention.

FIG. 6 shows a medical record folder, according to an exemplary embodiment of the present invention.

FIG. 7 shows a process for checking and authorizing destruction of records, according to an exemplary embodiment of the present invention.

### DETAILED DESCRIPTION OF THE INVENTION

The present invention provides for systems and methods for collecting, cataloguing, reproducing, and destroying records. Medical, legal, and other records from hospitals, medical offices, law offices, etc. are sent to a storage facility. Entry fields, such as name, record number, date of service, and date of birth, from each record are entered into a database. The database catalogues each record as well as the box the record is in and where the box is located. The system allows professionals to search the database over a secure connection. Multiple search fields allow a professional to search the database using any of a plurality of criterion though a single input field. Search logic enables a cross-field search for a specific query. When professionals request a record, the record is pulled at the storage facility and physically or electronically sent to the professional. The system also keeps track of records eligible for destruction as well as those destroyed. Files eligible for destruction are destroyed after the requisite permission is given.

“Record,” as used herein and throughout this disclosure, refers to any documentation concerning an individual in the course of health care, legal representation, education, etc. Examples of a record include but are not limited to a physician's file, a school transcript, an attorney docket, etc.

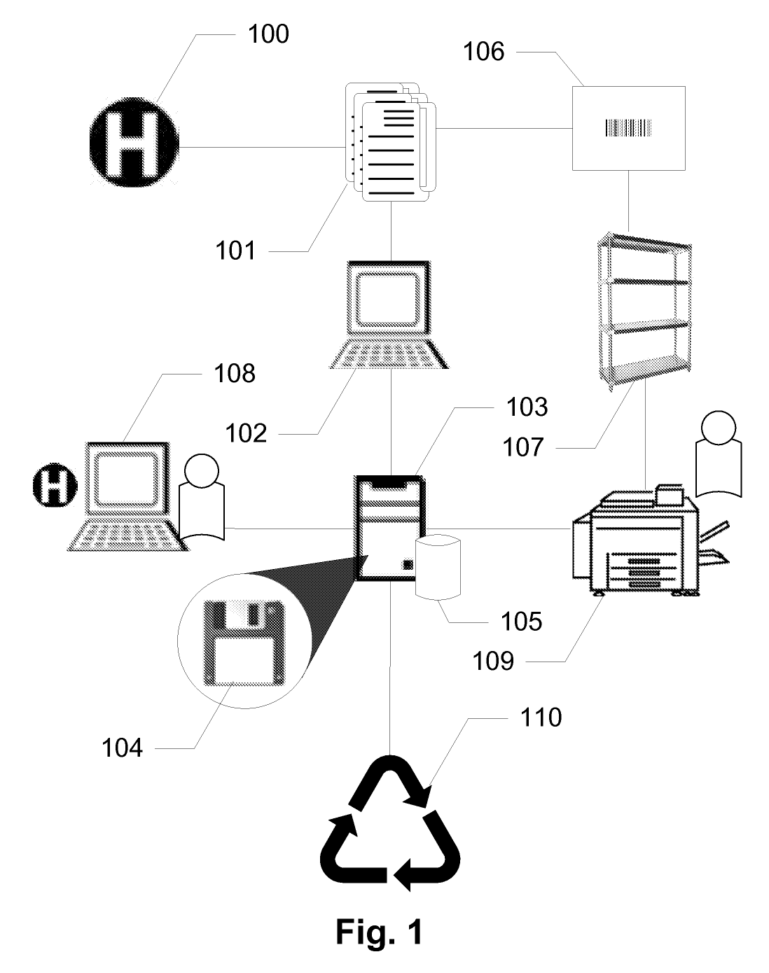

FIG. 1 shows a system for collecting, cataloguing, reproducing, and destroying documents, according to an exemplary embodiment of the present invention. In this embodiment, the system comprises medical records 101, a data input device 102, a box 106, a storage location 107, a server 103 with a database 105, a logic unit 104, and a records input 109. Medical records 101 are sent from a hospital 100 to a storage facility. When records 101 are received, often in boxes, a barcode is applied to each box 106 and box 106 is tracked such that the system knows where it is located. If record 101 is delivered without a box, it is placed into a box. Other forms of tracking may alternatively or additionally be used, such as infrared tags, radio frequency identification (RFID), etc. The tracking may require scanning the barcode when box 106 is moved, when it is placed on a shelf, when it leaves a building, etc. The boxes are each sent to data input device 102. Data input device 102 may have an employee manually entering each record's information into database 105 or may be an automatic scanning system. With a manual system, an employee uses a web interface or other software interface to enter the name, record number, date of service, and date of birth from each medical record. Alternative embodiments may also include entering the encounter number or any other index a facility needs. The system is preprogrammed based upon the client, such that the regulations and indexes match the client's needs. When entering information, logic 104 on server 103 knows which field is the date of service, date of birth, etc. so incorrect entries will automatically be flagged as errors. Reversing fields is automatically detected and flagged as an error. For instance, if date of service occurs before date of birth, logic 104 realizes that this is not possible. Logic 104 knows how long each number in each field should be. However, when typing in each field, the field allows for more characters than necessary. This allows logic 104 to detect human error, such as multiple strokes of the same key. For example, in a field where the number should be an eight digit number, the field allows for nine numbers. If nine numbers are entered, the field is flagged so that it may be corrected. Additionally, after completion of the entry, boxes may be spot checked to maintain quality control. Heavier quality control may be used for areas with typically more difficult name spellings. This ensures that all records have been entered into the system correctly. Records with which it might be necessary to determine retention time, such as those for mental incompetence or cancer studies, can also be flagged in the system. This notifies the system that these records may need to be retained longer, depending upon regulations.

In exemplary embodiments utilizing an automated entry system, record 101 is placed into a scanner. The scanner scans the folder of record 101 where the name, date of birth, date of service, and record number are located. A character recognition software is used to gather the information and the fields of the entry form are filled out. The software may be able to recognize the folder type, and thus know exactly where the desired information is located on the form. Alternatively, the recognized name and numbers are placed in the entry form based upon number length, chronological order, etc. The text on entered records is recognized using optical character recognition to pull letters and numbers from the record.

As record 101's information is entered into the system (through various possible methods, such as, for example, keying in, scan, optical character recognition (OCR), etc.), the system determines whether record 101 meets state guidelines for destruction, based upon comparing the information with rules within database 105. These rules are specified by HIPAA as well as other state and federal regulations. Records to be destroyed are separated into a destruction area 110, so that, with approval from the hospital, a destruction certificate is created and the files are destroyed. The creation of a destruction certificate may be programmed to be produced automatically upon destruction. Once all fields are complete, the entry is added to a relational database. The records remaining to be stored are placed back into the barcoded box 106 and placed in storage location 107. The barcodes are tracked with a barcode wand during this time so that the exact location of every record is in database 105. Record 101 is paired with box 106 in which it is located and the system flags an error if record 101 is placed in the incorrect box.

In an exemplary embodiment of manual entry, an employee at a workstation opens a box of records from the hospital. In front of the employee are two barcoded boxes, one for storage and one for authorization for destruction. As the employee enters in the information from each record, the system notifies the employee whether the file is eligible for destruction or whether it should be stored. If the record is eligible for destruction, the employee places the record in the destruction box and scans the barcode of the box to inform the system of the placement. If the record is to be retained for storage, the employee places the record in the storage box and scans the barcode to inform the system that the record is being stored in the storage box. If in either of the two scenarios the employee places the record in the incorrect box, the system notifies them. The notification may be in the form of a red X, an inability to move to the next file, an audible alert, etc. In embodiments of the present invention, the employee creates two piles on their desk of records they believe will be destroyed and those they believe will be stored in order to increase their own performance.

Database 105 allows for a generic search across all database entries, with all fields searched during a query. For example, if a health care professional 108 connects to the system through server 103 and searches a number, the system searches the patient name field, the record number field, the encounter number field, and any other defined field. The system then returns the results. Thus, health care professional 108 querying the system does not need to know whether the number they have is the record number, encounter number, etc. When health care professional 108 has identified the record they need from database 105, health care professional 108 requests the document. This request may be done electronically, by fax, over the phone, etc. A storage facility employee receives the request, pulls the record based upon the exact location given by database 105, and scans it into records input 109. Records input 109 uploads the record to secure online server 103, where health care professional 108 may access the record. This allows health care professional 108 to receive the record in a timely manner. Alternatively, after locating the record, the employee may fax or otherwise distribute the file to health care professional 108. In exemplary embodiments of the present invention, one entry system functions as both data input device 103 and records input 109.

In an exemplary embodiment, the system runs on a LINUX web server. This embodiment does not require any software installation by the hospital or medical professional. The search software is a plug-in integrated into the web interface. Additionally, the storage facility does not need to install its own software as the web interface allows for a software as a service (SaaS) approach.

Embodiments of the present invention also include a phonetic spelling search in addition to an exact name search. Names that were originally entered incorrectly or are searched for incorrectly based upon phonetic misspellings are found through this search. This also allows a user to search for a name even when they are not sure of the exact spelling. The phonetic spelling search is accomplished using the Soundex algorithm or other algorithms known in the art.

In embodiments of the present invention, the system also generates reports, specifying records that are eligible for destruction or are approaching that point. These records may be eligible for destruction for various reasons, such as date of service, date of birth, etc. The system generates spreadsheets for the hospital, including the records eligible for destruction, the reason for their eligibility, and the boxes they are placed in. The hospital checks over the spreadsheet, gives approval, and has the records destroyed and destruction certificates made per guidelines. After records are pulled from a box and destroyed, the box may contain extra space. To allow for efficient storage, boxes are consolidated by moving files from one box to another. The location of the file within the different box, as well as the location of the different box, is entered into the system using a barcode scanner, etc.

The destroyed record numbers may be recorded onto spreadsheets, along with the patient name, destruction certificate identification, date of birth, date of service, etc. With this information, hospitals can respond to a third party request for the record with exact details regarding the destruction of the record. This information may be used in such instances as defense against lawsuits. When an attorney requests a record, a hospital can respond by not just telling the attorney the record has been destroyed, but actually producing a certificate of destruction identifying the record and stating that it has been legally destroyed.

The system may be synced with the Master Patient Index (MPI) of a hospital. The fields entered into the system may be designed to match those of the MPI of a hospital. This allows all records, not just those in storage, to be located and searched for a given patient. The system gives the hospital an electronic spreadsheet, which is an accounting of all the charts they have done for the past years. The system gives them an interface to find and access these files in a timely manner. The system also allows a storage facility employee to simply enter an encounter or medical record number, with the rest of the data needed to fill every index pulled from already existing electronic data. The hospital additionally is able to pair all these records, including the documentation of records that have been destroyed, allowing for an efficient search of all records.

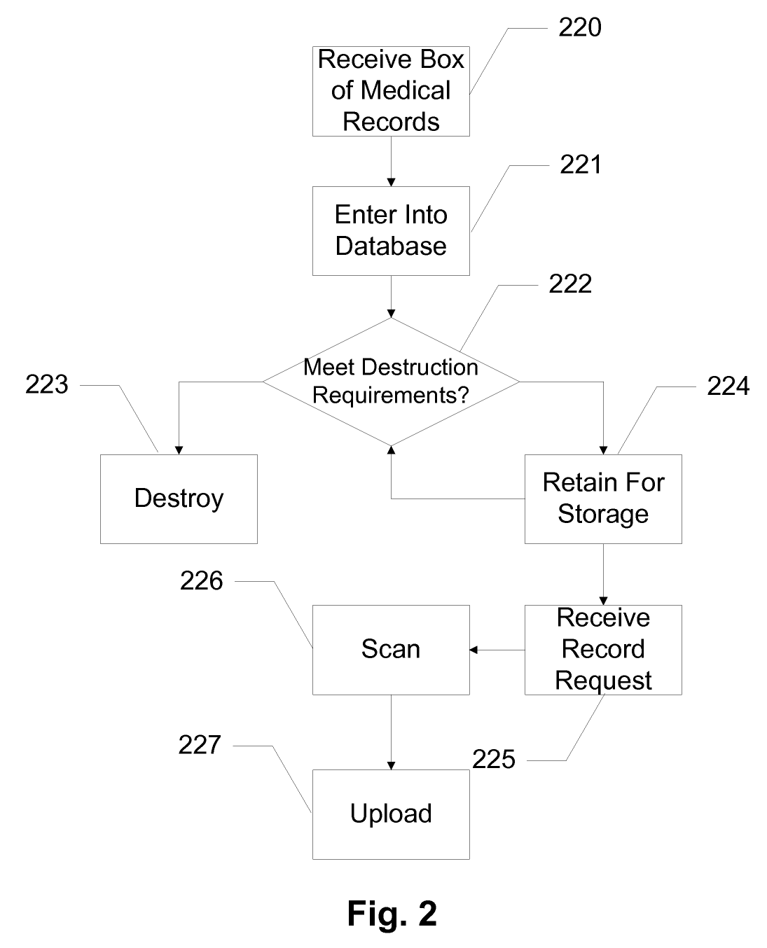

FIG. 2 shows a flowchart of a method of collecting, cataloguing, reproducing, and destroying records, according to an exemplary embodiment of the present invention. The method begins with the reception of a box of records from a hospital 220. Each record within the box is entered into a database 221. The name, record number, date of service, and date of birth are all entered into the database. The system queries whether or not the records meet the requirements for destruction 222. These requirements are based upon state and federal regulations. If the requirements are met, the system requests approval from the hospital and, upon receipt, destroys the records 223. The system will also document the destruction of the record. If the record does not meet the requirements for destruction, the record is retained for storage 224. The record is placed back into a box with the box and record paired in the database. This may be accomplished by scanning a barcode, manually entering the box number, etc. After the record has been stored, a logic unit periodically queries the database to determine whether any more records are eligible for destruction 222. If so, approval is gained from the hospital and the record is destroyed 223. Records that remain in storage can be requested by health care professionals. This request may be made online through the system, over the phone, by fax, etc. When a request is received 225, an employee or automated process matches the record request to the box of the record and removes the record. The record is scanned 226 and uploaded 227 into the system where the health care professional may access the record.

Automatic reports can be generated at any point or interval of time, specifying which records are eligible for destruction, which have already been destroyed, etc. These reports are sent to the client for approval before any destruction occurs. When desired, or scheduled, the system can automatically determine which records are eligible for destruction. The system makes the determination based on the fields entered and destruction guidelines for all fifty states. In exemplary embodiments, this is done every two years, to prevent the waste of time and money pulling only a few records. The report specifies exactly in which box each record is contained such that the record can be easily pulled out. The report may also determine that a box is getting low on records and can be consolidated. This allows the client to save storage costs by only using warehouse space that is necessary.

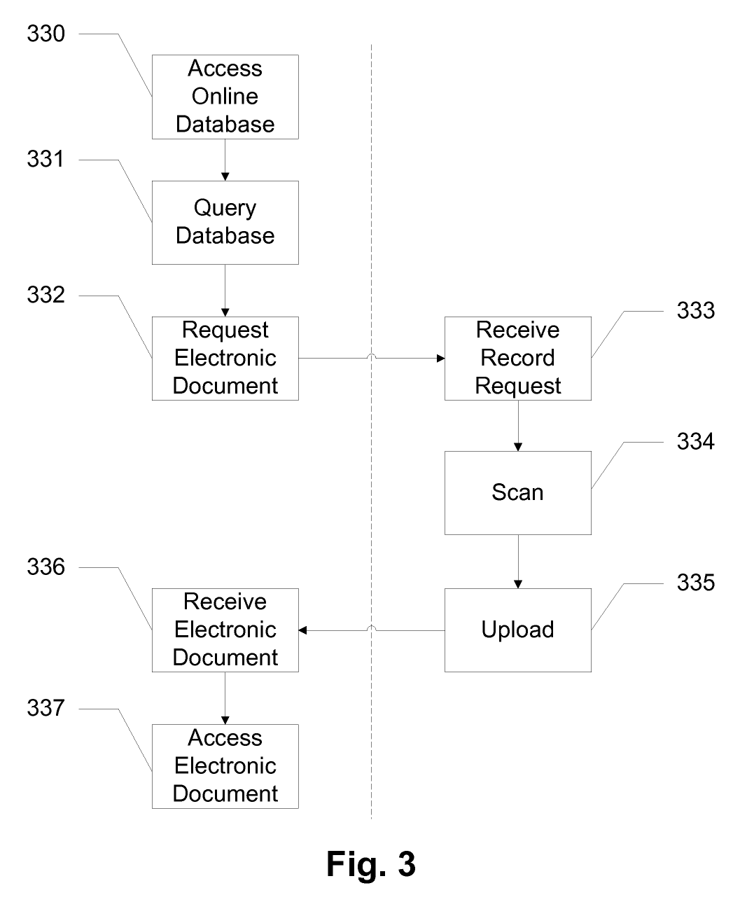

FIG. 3 shows a flowchart of the retrieval of records by a professional, according to an exemplary embodiment of the present invention. In this embodiment, a health care professional seeks the medical records for a patient. The professional accesses an online database 330 containing the status and location of stored medical records. The access is provided by a secure online web server with search fields provided and, in certain embodiments, tailored to the specific user. The professional queries the database 331, entering the patient's information into the search fields. This may simply be the patient name, even misspelled. The server's logic searches the database for occurrences of the entered field or fields. For the name field, phonetic equivalents may also be searched. Results of the search are displayed to the professional and can be based upon relevance, exact matches, etc. When the professional has found the needed record or records, the professional requests the record 332. The storage facility receives the request 333. A facility employee matches the record with the location of the record. This may include the box the record is in as well as the location of the box. Once the record is located, the facility employee scans the requested document 334. The document is then uploaded into the database 335, where it is accessed. The professional receives the record 336 over the web interface or uploads the record from the server. The professional then accesses the electronic form of the record as needed 337.

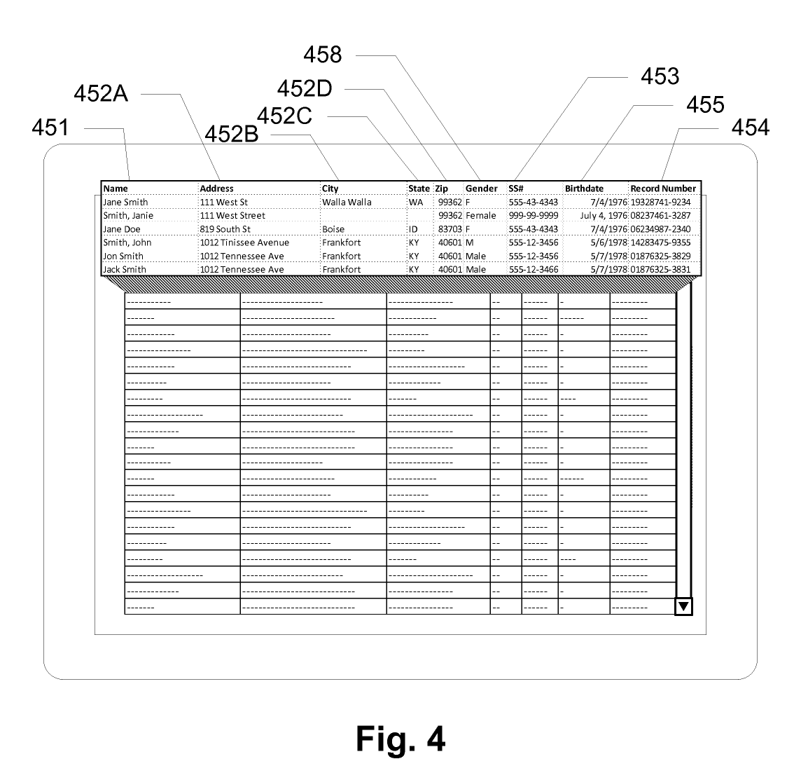

FIG. 4 shows a sample screen of a MPI, according to an exemplary embodiment of the present invention. The MPI is a list of patient information associated with a record number 454. The patient information includes a patient's name 451, an address 452A, a city 452B, a state 452C, a zip code 452D, a social security number 453, a birth date 455, and a gender 458. The MPI is used as the base for developing the searchable database.

Medical professionals may only have a patient's driver's license when the patient is brought in after a crash. The professional types in any information on the driver's license, such as the name and date of birth. The system searches all records under the name and/or date of birth, displaying search results back to the professional. The results tell the professional which records are available as well as where they are located. The professional requests the document, which is then scanned into the system for the professional to retrieve. This allows the professional to quickly retrieve potentially life saving information that might otherwise be lost, such as allergies, a heart condition, etc. If the full index entry is not known for some reason, the known portion followed by a wildcard, such as an asterisk, can be entered to give results including that portion given. An entry of “Joh*” returns all instances of “John” and “Johnson”. This allows the system to provide results even with very little information known by the professional.

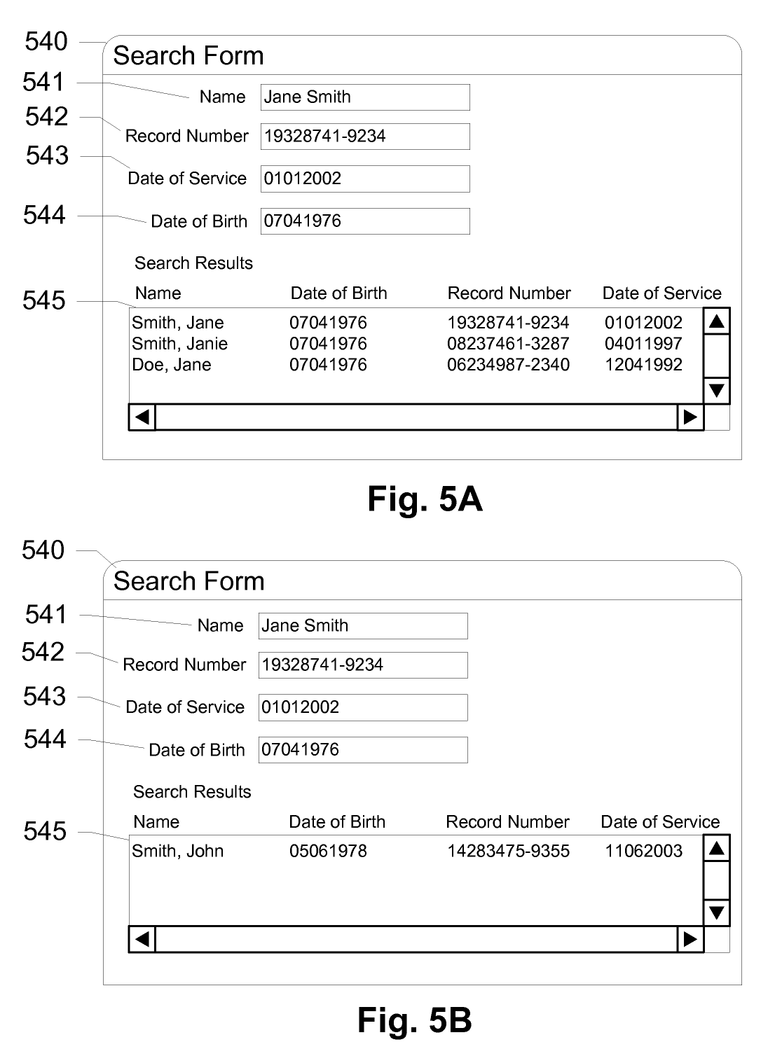

FIG. 5A shows a search form 540, according to an exemplary embodiment of the present invention. In this embodiment, search form 540 comprises a name entry field 541, a record number entry field 542, a date of service entry field 543, a date of birth entry field 544, and a search results field 545. A health care professional fills out one or more of the entry fields and receives search results in search results field 545. For example, in FIG. 5A, the professional has entered the name Jane Smith into name entry field 541, record number 19328741-9234 in record number entry field 542, 01012002 in date of service entry field 543, and 07041976 into date of birth field 544. The system searches a database for records containing matches to any of these fields. The results are returned to the professional in search results field 545. The results show matching names as well as generic last names, such as Doe, that may have been entered due to an unknown last name. The date of birth, record number, and date of service are also displayed for each entry. The professional decides which file they would like and requests it from the storage facility where the files are kept. The results may also return to the professional which box number the records are located in, as well as the location of the box. Alternatively, this is displayed only on the storage facility side, such that upon request of a record, the system informs the facility of the location and number of the box.

FIG. 5B also shows a search form 540, according to an exemplary embodiment of the present invention. In this embodiment, search form comprises a name entry field 541, a record number entry field 542, a date of service entry field 543, a date of birth entry field 544, and a search results field 545. However, in this form, the health care professional has entered a number into the wrong field. The health care professional has entered a name, John Smith, into name field 541 but then entered the record number into date of service field 543. The system searches across all fields for each of the entered fields. Therefore, the record number for the desired record will appear in search results. Search results may be weighted based upon user preferences. For instance, exact record number may be the most desired criteria, and thus would appear on the top of the list for a record number search. When a name is entered, exact spellings may be weighted more than phonetic spellings, and so forth. These settings may appear as a button or other type of selection in the search form. Additionally, the professional could click on the top of a column of search results to sort the results based upon that column.

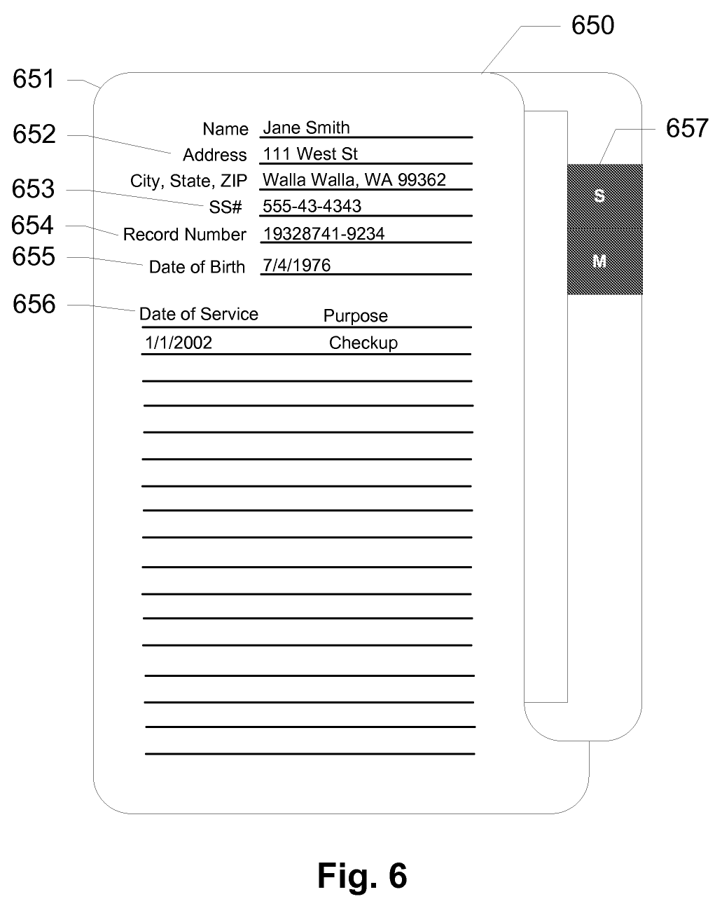

FIG. 6 shows a medical record folder 650, according to an exemplary embodiment of the present invention. In this embodiment, medical record folder 650 contains patient information on the cover. Patient information may include a patient name 651, an address 652, a social security number 653, a record number 654, a date of birth 655, and dates of service 656. This information can be entered into a system for collecting, cataloguing, reproducing, and destroying documents. Additionally, a tab 657 on medical record folder allow for easier search within a box of documents, after the exact box and location has been determined.

The present invention can also be used when a hospital stores its own records. Because data is entered into a web server, the system can be implemented anywhere. A crew could be sent on site to the hospital for sorting and documentation of the records at the hospital. Similar to a system in a storage facility, the boxes are tagged, such as with barcodes, to identify the location of every record and every box. Once the system is created, a health care professional may search the database to determine where a record is stored. A hospital employee locates the record in the box exactly like an employee at a storage facility. The system alerts the hospital as to records eligible for destruction, which the hospital may destroy themselves or through an outside service.

Embodiments of the present invention may be implemented with records other than paper records. For instance, the present invention may be utilized with microfilm or microfiche. Many records were converted to these formats such that facilities may have cabinets of rolls of microfilm. Similar to a system with paper files, storage facility employees use microfilm readers and enter data into fields of the web interface. The employee documents the exact location of each roll of microfilm as well as the location on the microfilm. Destruction of the microfilm is accomplished similar to the paper system.

Additionally, the present invention may be used for electronic records. Many hospitals are switching to purely electronic records. However, these systems generally store every piece of information for every patient forever, without any plan for destruction. From both a legal and technical standpoint, the destruction of records according to guidelines is ideal. Much of the scanned records eligible for destruction bog down a hospital's system and can be deleted, similar to destruction in a paper system. The present invention may be utilized for these electronic records, notifying health care professionals of records eligible for deletion.

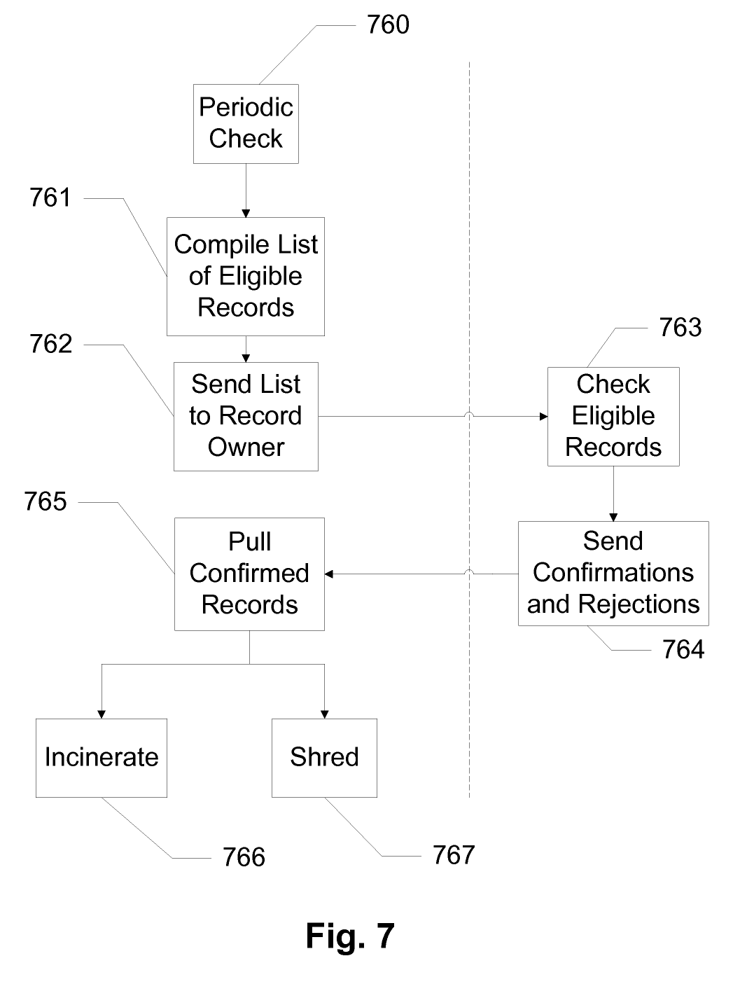

FIG. 7 shows a process for checking and authorizing destruction of records, according to an exemplary embodiment of the present invention. The process begins with a periodic check of all the records in the database to determine which, if any, are eligible for destruction according to state and/or federal guidelines 760. This periodic check can be once a day, once a month, upon user event, etc. Once the database has been thoroughly checked, a list of all records eligible for destruction is compiled 761. The list of records eligible for destruction is then sent to the owner for verification 762. The owner of the records may need to confer with the latest laws and regulations before giving the final authorization to destroy the eligible records 763. Once the owner has reviewed the list, the owner sends a confirmation or rejection for each eligible record 764. Once the list of confirmations and rejections has been received, the records which have been confirmed for destruction are pulled from the box 765. The eligible records confirmed for destruction are then either shredded 767 and perhaps recycled, or incinerated 766. In other embodiments, the records are converted to digital copies. For these digital record embodiments, the records may simply be deleted from the memory. After deletion, additional steps may be taken to ensure the information cannot be retrieved from the digital medium.

Embodiments of the present invention are easily adapted for many different environments. For instance, any area or industry where the retention and destruction of records is important would benefit from the present invention. Among these areas are schools and law offices. Both student records and legal files must be maintained for specific periods of time before destruction is necessary. The present invention, with alternative entry fields, allows for an organized retention and destruction, according to guidelines.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for collecting, cataloguing, reproducing, and destroying a record comprising:
a server;
a database in communication with the server;
an entry device in communication with the server for entering data from a record;
a logic on the server;
a storage medium for storing the record; and
a destroyer for destroying the record when the record is eligible for destruction;
wherein the logic provides a search engine for a user to search the database, and alerts a user when a record is eligible for destruction.

2. The system in claim 1, wherein the entry device inputs selected information from a record into the database.

3. The system in claim 2, wherein the selected information is a name, a date of birth, a date of service, and a record number.

4. The system in claim 2, wherein the selected information is input manually on a keyboard.

5. The system in claim 2, wherein the selected information is read using optical character recognition.

6. The system in claim 1, wherein the entry device converts an entire record to an electronic format and stores the electronic format in the database.

7. The system in claim 1, wherein the search engine searches the database for a plurality of exact matches and a plurality of possible matches.

8. The system in claim 1, wherein the logic monitors the database for records eligible for destruction.

9. The system in claim 1, wherein the storage medium provides one of physical and electronic storage.

10. The system in claim 1, wherein the destroyer is one of an incinerator and a shredder.

11. A system for checking and destroying a record from a database of records comprising:
a plurality of records;
a means for periodically checking the plurality of records for destruction eligibility; and
a means for destroying a record eligible for destruction,
wherein destruction eligibility is in accordance with a plurality of guidelines.

12. A method of improving record destruction, comprising:
cataloguing a plurality of records into a database;
monitoring the database for a record eligible for destruction; and
destroying the record eligible for destruction.

13. The method in claim 12, further comprising collecting a plurality of records.

14. The method in claim 12, further comprising organizing and storing the plurality of records based upon the database.

15. The method in claim 12, wherein the monitoring further comprises comparing a record with a plurality of destruction guidelines.

16. The method in claim 12, further comprising requesting permission before destroying the record.

17. The method in claim 12, wherein the destroying comprises one of burning, shredding, and deleting the record.

18. A method of improving record destruction of the type involving monitoring a database, which corresponds to a plurality of physical records, to find a physical record eligible for destruction, comprising:
destroying the physical record eligible for destruction.
wherein the physical record is found eligible for destruction according to a comparison of the database with a plurality of guidelines.

19. A method for improving medical record retrieval and destruction efficiency, comprising:
cataloguing a plurality of medical records into a database;
searching the database for a plurality of exact matches and a plurality of possible matches; and
retrieving a medical record from the database;
wherein the plurality of possible matches is included to improve a search result.

20. The method in claim 19, further comprising collecting a plurality of medical records.

21. The method in claim 19, further comprising organizing and storing the plurality of medical records based upon the database.

22. The method in claim 19, further comprising providing a search engine interface to a medical professional.

23. The method in claim 22, wherein the search engine interface is accessible over the Internet.

24. The method in claim 22, wherein the search engine corrects certain forms of human error.

25. The method in claim 19, further comprising selecting a search result.

26. The method in claim 19, wherein the retrieving further comprises converting a physical medical record into a digital medical record.

27. The method in claim 26, wherein the retrieving further comprises electronically sending the medical record to a medical professional.

28. The method in claim 19, further comprising monitoring the database for medical records eligible for destruction according to a plurality of guidelines.
